(19) United States
(12) Patent Application Publication
(10) Pub. No.: US 2011/0153406 A1
(43) Pub. Date: Jun. 23, 2011

(54) Tracking and Processing Discount Cards

(75) Inventors: Terrence Christian Mackin, Bloomington, MN (US); Sarah Piket, Maple Grove, MN (US); Elizabeth Maria Henrich, Becker, MN (US); Michael Shawn Whitsitt, Lakeville, MN (US)

(73) Assignee: TARGET BRANDS, INC., Minneapolis, MN (US)

(21) Appl. No.: 12/641,009

(22) Filed: Dec. 17, 2009

(51) Int. Cl. G06Q 30/00; G06K 5/00

(52) U.S. Cl. 705/14.35; 235/380; 705/14.38

(57) ABSTRACT

In one example, a stored value card system is modified to process discount cards that are capable of providing varying percentage discounts on an array of products or services that can be purchased by a consumer. Implementations of the stored value card system can include modifications that allow a transaction using the discount card to pass through as an authorized transaction in spite of, for instance, application software logic that otherwise rejects transactions for stored value cards having a zero balance. For example, when the modified stored value card system detects a transaction involving a discount card, an authorization system within the modified stored value card system can generate an alternative error code that prevents the point of sale system from rejecting the transaction due to a zero balance.

### BACKGROUND

Consumers buy products or services at various locations, such as point of sale (POS) terminals at stores, kiosks at a shopping mall or an airport, vending machines, online shopping websites, by mail, or over the telephone. Regardless of the location, transactions involve products or services purchased using some kind of tendered payment (e.g., cash, credit, etc.).

At POS locations, such as a customer's local department store, grocery store or discount store, consumers bring their merchandise to a sales representative (or cashier) who operates a POS terminal, such as a computerized cash register tied to a POS system. The cashier typically scans the items' UPC codes or other machine-readable identification using components integrated with the POS terminal. In some cases, the prices are read from price tags attached to the items to be purchased and entered manually into the POS terminal. Some stores include one or more POS terminals in “self-service” check-out lanes in the store, and the customer scans the items while interacting with the POS user interface. In any case, the transaction generally concludes with payment and the generation of a receipt.

Methods of payment used by the customer include cash, personal checks, credit cards, debit cards, food stamps, vouchers, coupons, and so on. Some transactions involve more than one method of payment, such as if the customer presents coupons and/or food stamps to reduce the total, then charges the remaining purchase amount to his credit card or debit card, or pays with cash or a check.

Various types of cards used in transactions include debit cards, credit cards and discount cards. Typically, discount cards offer a percentage (e.g., 10%) off particular products, or in some cases, the entire purchase. During a transaction using a discount card, the discount card is scanned to “read” the discount applicable to the card, and the discount is applied to the customer's purchase.

### SUMMARY

In one example, a stored value card system is modified to handle discount cards that are capable of providing varying percentage discounts on an array of products or services that can be purchased by a consumer. In some implementations, a merchandising system within the modified stored value card system can send stored value cards to a group of consumers, such as employees in a company that qualify to receive an extra 10% off certain brands or private label products. The consumer can receive his discount card in the mail, for example, with an accompanying mailer that is printed with logos of specific brands or products for which the discount card applies. In some embodiments, the consumer can use his discount card at any point of sale system where debit cards, stored value cards and credit cards are accepted. Implementations of the stored value card system can include modifications that allow any transaction using the discount card to pass through as an authorized transaction in spite of, for instance, any application software logic that otherwise rejects transactions for stored value cards having a zero or insufficient balance. For example, when the modified stored value card system detects a transaction involving a discount card, an authorization system within the modified stored value card system can generate an alternative error code that prevents the point of sale system from rejecting the transaction due to a zero balance.

The details of one or more implementations are set forth in the accompanying drawings and description below. Other features, objects, and advantages will be apparent from the description and drawings, and from the claims.

### DESCRIPTION OF DRAWINGS

FIG. 1 illustrates an example system for tracking and processing discount cards.

FIG. 2 illustrates an example mailer for sending a discount card.

FIG. 3 is a flow chart showing an example process for processing a discount card within a stored value card system.

FIG. 4 is a swim lane diagram that illustrates an example process for handling discount cards within a stored value card system.

FIG. 5 is a block diagram of a computing system optionally used in connection with computer-implemented methods described in this document.

Like reference symbols in various drawing indicate like elements.

### DETAILED DESCRIPTION OF ILLUSTRATIVE EMBODIMENTS

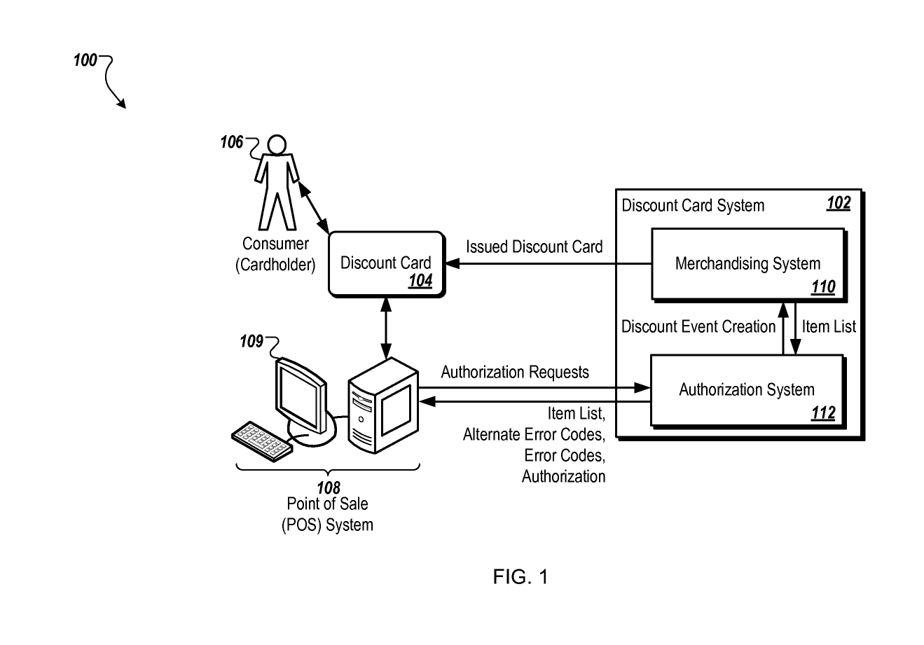

FIG. 1 illustrates an example system 100 for tracking and processing discount cards. The system 100 includes a discount card system 102 from which discount cards 104 are issued to consumers 106. After card issuance, the discount card system 102 tracks and supports the use of the discount cards 104 in card-based transactions made by the consumers 106. Transactions involving the issued discount cards 104 occur, in this example, at one or more point of sale (POS) systems 108. Each POS system 108 includes one or more POS terminals 109, each capable of being operated, for example, by a cashier while processing the transaction for a particular consumer 106. In some embodiments, other transactions in which consumers 106 use discount cards 104 occur online (e.g., in Internet-based shopping, using forms on Web pages, etc.) or over the phone (e.g., in catalog sales or other telephone-based purchases). Discount cards 104 generally include, for example, gift cards, employee reward cards, loyalty cards, cash-loaded cards, or any other transaction cards. However, the examples provided in the present disclosure focus primarily on discount cards 104 that provide the cardholder (e.g., the consumer 106) with percentage discounts applicable to particular items.

In some embodiments, conventional systems that normally handle stored value cards (such as gift cards) and credit cards are modified to support the use of discount cards 104. For example, the modifications allow the discount card system 102 to overcome issues raised (e.g., zero balances, zero amount transactions, etc.) by the inclusion of discount cards 104 in the mix of existing transaction cards. In the example configuration shown in FIG. 1, issues related to discount cards are handled by a combination of the discount card system 102 and the POS system 108.

In some implementations, the POS terminals 109 include modified or additional displays, prompts and notifications associated with processing discount cards. Changes to the user interface, for example, allow the POS terminals 109 to be used for processing discount cards as well as existing debit cards or other balance- and credit-oriented cards generally supported by the POS terminals 109. In some implementations, the software modifications are relatively minor, such as to overcome certain issues related to discount cards.

One example issue related to handling discount cards 104 is the consideration of a zero balance on a discount card 104. For instance, during a transaction involving a stored value card a zero balance associated with the stored value card causes the transaction to be rejected. Unmodified stored value card systems that attempt to process discount cards (e.g., having no balance) in the same way as stored value cards, for example, would typically result in rejected transactions. In embodiments associated with the system 100, balance restrictions are not applicable to discount cards 104, as discount cards typically carry no actual balance, but instead exist primarily to provide percentage discounts on specific items. In some embodiments, in order to overcome the zero balance issue, the system 100 includes modifications over a conventional stored value card system. For example, the modifications allow transactions using the discount card 104 to proceed despite any software application logic (e.g., in the stored value card system) that would otherwise reject a transaction due to balance restrictions. In typical stored value card systems described in the current example, software application logic that blocks zero-balance transactions exists in POS systems as well as any card handling systems with which they interact. However, in the example system 100, modifications exist that allow zero-balance transactions for discount cards 104 to pass through successfully. Specific details of these and other embodiments are described below.

In the example configuration of the system 100 illustrated by FIG. 1, the discount card system 102 includes a merchandising system 110 and an authorization system 112. In some implementations, the authorization system 112 includes software applications that use transaction card information to facilitate tracking and processing of transaction cards, including discount cards 104. In the example configuration illustrated in FIG. 1, the authorization system 112 includes any one of, or a combination of, various transaction systems, banks or other financial institutions. In some embodiments, the authorization system 112 tracks discount cards 104 from the time they are authorized, assigned, and ultimately used by people who are customers at stores where the discount cards 104 are used. In the configuration shown for the current example, the authorization system 112 interacts with the merchandising system 110, sharing information regarding, for instance, discount events and lists of items to be discounted as part of those events. In some implementations, the merchandising system 110 is any one of or a combination of a product marketing system, an inventory and pricing system, or any other system for marketing merchandise. Example types of discount events include sales promotions, reward campaigns, employee appreciation, profit sharing, etc.

In the example configuration of system 100 shown, the authorization system 112 interacts with the merchandising system 110, for example, to create a discount event. In some embodiments, the merchandising system 110 identifies merchandise, such as inventory items, that are appropriate for being offered at a discounted percentage for participants of the discount event. As a result, the merchandising system 110 provides, for example, a list of the discountable items to the authorization system 112, which forwards the list to the various POS systems 108. In some embodiments, the merchandising system 110 directly provides the list of the discountable items to the various POS systems 108. Having identified the discountable items, in some embodiments, the merchandising system 110 issues the discount cards 104 to individuals designated to receive the cards. Identifying the card recipients, for example, is based on determining valued customers or company employees who are eligible for gifts or other tokens of appreciation which, for instance, are provided in the form of discount cards 104. Some embodiments of issuing the discount cards 104 include direct mail, email or other delivery methods.

In some implementations, the system 100 includes a reporting system operable to provide discount card balances, discount event summaries, discount item statistics, and user statistics. For example, at any given time, the reporting system is capable of identifying the state of any discount event, including the consumers who have already participated, the items they have purchased, and their total savings.

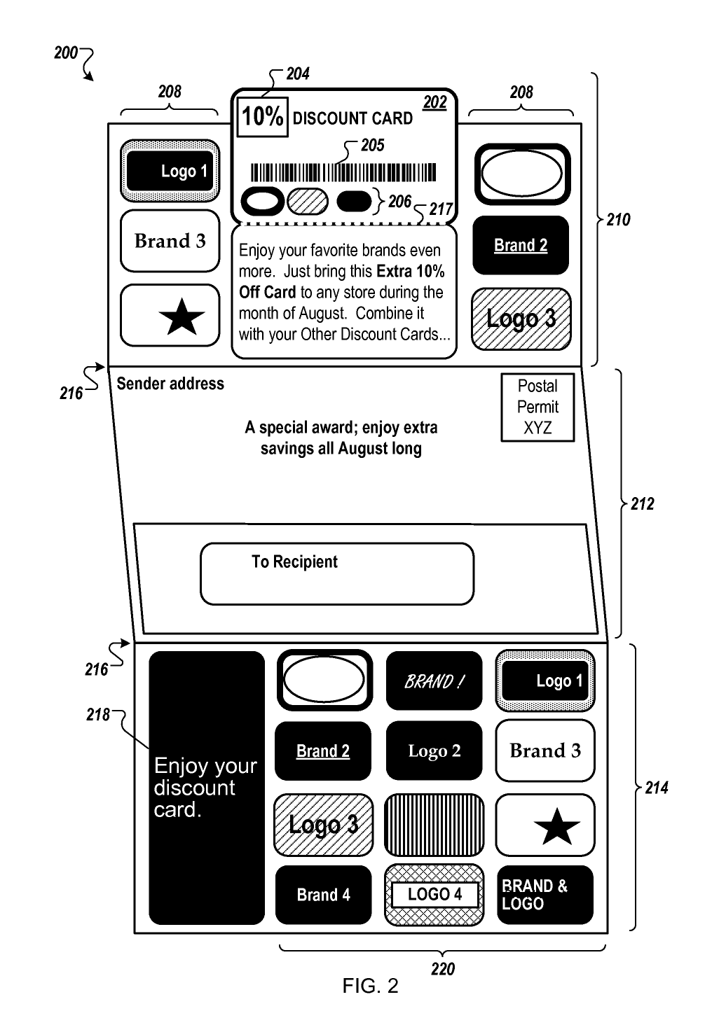

In some embodiments, when the discount card 104 is issued to a card recipient, the card is optionally accompanied with printed information including logos or other identification of products that are discountable when using the discount card 104. An example mailer with this information is described below with respect to FIG. 2.

Once the discount cards 104 are issued, some embodiments of the system 100 include interactions between the POS system 108 and the authorization system 112. For example, during a transaction in which the cardholder uses the discount card 104 at the POS system 108, the authorization system 112 ultimately authorizes or rejects the transaction. In some embodiments, the authorization process begins when the POS system 108 requests an authorization from the authorization system 112. For example, in some embodiments, the authorization process includes identifying discount card account information (e.g., account number, discount event, etc.), card status, and transaction information (e.g., items to be purchased and purchase amount).

In the example configuration of system 100, communication among the components of system 100 occurs over any network, including any combination of the Internet, local area networks (LANs), wide area networks (WANs), and so on. As an example, the authorization system 112 communicates with any particular POS system 108 using the Internet, such as when the authorization system 112 is in one city and the POS systems 108 are geographically dispersed in several locations. Using the Internet, for example, the POS system 108 sends authorization requests to the authorization system 112, which further provides the POS system 108 with a list of discountable items (e.g., sometime before POS transactions occur), transaction authorizations (and rejections), and various error codes. In some embodiments, the error codes include alternative error codes, which will be explained in detail below.

In some implementations, POS terminals 109 communicate with the POS system 108 using a LAN, such as if the POS terminals 109 are all located in the same store. Alternatively, communication between the POS terminals 109 and the POS system 108 occurs using a WAN, for example, if the POS terminals 109 are geographically dispersed, such as throughout the country or the world.

FIG. 2 illustrates an example mailer 200 for sending a discount card 202. In some implementations, the mailer 200 is used for delivering discount cards 104 to consumers 106.

The example discount card 202 includes a printed discount percentage 204 (e.g., 10%) that identifies the percentage discount available on items purchased while using the discount card 202. In this example, a scan bar 205 or other machine-readable characters and/or embedded information provides the ability to automatically scan and verify the card. Other examples of electronic signatures or security features that discount cards 202 optionally include are RFID chips, magnetic strips, card security codes, holograms, and micro-printing. In some implementations, the information read from the discount card 202 identifies the account number of the discount card (or associated event number), allowing the POS system 108, for example, to automatically access the discount percentage from the computer. In some embodiments, one or more brand logos 206 on the discount card 202 identify the particular brands or private labels for which products within that brand group are to be granted the discount percentage 204. In this example, the same or different brand logos 208 are printed on the mailer 200 adjacent to the discount card 202.

In the example embodiment shown in FIG. 2, the mailer 200 includes a top portion 210, a middle portion 212, and a bottom portion 214. In the current example, the portions 210-214 are part of a single card stock, attached at folds 216. In some embodiments, the discount card 202 is easily detachable by the card recipient, such as by using a perforated fold 217. In some implementations, the mailer 200 optionally includes a marketing message 218 and brand logos 220 that identify brands for which discounts apply and/or are designed to entice the card-holding consumer to buy specific products.

In some implementations, in addition to (or in place of) the mailer 200, consumers receive notifications regarding new discount events as well as updated information during a particular discount event's effective period. The notifications include, for example, email, telephone voice and text messages, etc. In some implementations, notifications include announcements of temporary increases to percentage discounts on certain items, such as all products or services within a particular brand or private label.

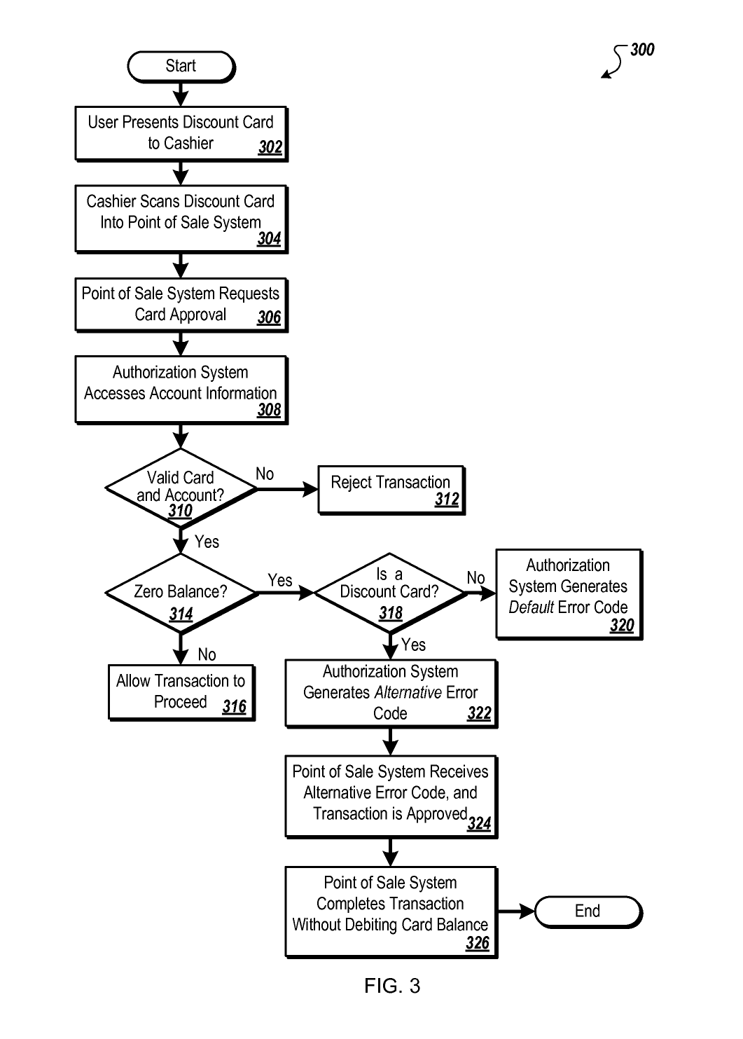

FIG. 3 is a flow chart showing an example process 300 for processing a discount card within a stored value card system. In some embodiments, the process 300 is used for handling discount cards within the system 100.

A cardholder performs the step of presenting 302 a discount card to a cashier. For instance, referring to the example configuration of FIG. 1, a card-holding consumer 106 presents the discount card 104 to the cashier operating a POS terminal 109 communicatively coupled to the POS system 108. Presenting the discount card 104, for example, is part of a purchase transaction. The consumer completes the purchase transaction, for instance, by presenting one or more types of payment, including debit cards, credit cards, cash, check, etc. In some implementations, the consumer 106 presents the discount card 104 at the beginning of the transaction, for instance, so that discounts available for purchased items are applied as the items are scanned or otherwise handled by the cashier. In some implementations, presenting the discount card 104 just before or after the calculation of a total purchase amount still allows the POS system 108 to provide any applicable discounts, adjusting the transaction total as needed.

A cashier performs the step of scanning 304 the discount card into the point of sale system. As an example, a cashier operating a POS terminal 109 scans the discount card 104 into the POS terminal 109, and thus into the POS system 108. When the discount card 104 is scanned, for instance, card information (e.g., the account/card number, discount event number, etc.) is automatically entered into the POS system 108.

A point of sale system performs the step of requesting 306 card approval. For example, having scanned the discount card 104, the POS system 108 requests approval of the discount(s). In some implementations, the approval request is sent to the authorization system 112.

An authorization system performs the step of accessing 308 account information. As an example, the POS system 108 provides transaction information, including the account number of the discount card 104, to the authorization system 112. In some embodiments, the authorization system 112 uses the account number to access the account balance, an item list for which discounts are available, and the valid effective period for those discounts. In some implementations, the authorization system 112 also determines, such as based solely on the account number, that the type of transaction card being used in the transaction is a discount card, as opposed to a debit card, for instance.

In some implementations, a consumer's existing debit or credit card is enhanced as part of a discount card program. For example, the merchandising system 110 that issues discount cards 104 instead optionally updates a consumer's existing stored value card with the ability to be used further as a discount card. In this example, the merchandising system 110 is spared the expense of printing and mailing information (e.g., the mailer 200) to the consumer 106. In some implementations, the consumer 106 learns of the discounts by email or some other form of communication.

An authorization system performs the step of determining 310 if the discount card and the corresponding account are valid. In some implementations, the determination of account validity includes, for example, whether the discount card 104 is expired or unexpired, whether it is being used during the effective period of the discount event, whether the account associated with the discount card 104 is still open and authorized for use, or whether the discount card 104 is qualified for use with any items in the transaction, etc.

If the discount card or corresponding account is invalid, an authorization system performs the step of rejecting 312 the discount card. In some implementations, rejecting the card includes the generation of an error message that is provided to the POS system 108 and displayed, for instance, on the POS terminal 109 being operated by the cashier who is handling the transaction for the consumer 106. In some embodiments, “rejecting” a discount card allows the transaction to proceed, but simply results in the generation of an error message, readable by the cashier, such as “no items in transaction qualify for discounts associated with this card,” or “consumer discount already taken.”

In some implementations, each discount event has an effective period that includes an activation date and/or time and a deactivation date and/or time. For example, discount cards (e.g., discount card 104) are valid only during the discount event's effective period. In some implementations, during authorization of a transaction using the discount card, the authorization system 112, for example, makes a determination whether the discount event is still in effect. At the same time, the authorization system 112, or optionally the POS system 108, determines if items included in the transaction are associated with the discount event. In some implementations, when no items included in the transaction are discountable, an error code is generated, and the POS system 108 allows the transaction to complete. Over time, in some embodiments, upon the arrival of the deactivation date and/or time, the discount card 104 is automatically closed and the POS system 108 stops accepting the discount card 104. In some implementations, use of a discount card 104 automatically deactivates the card, such as in a one use only discount event.

In some implementations, the POS system 108 prevents multiple unauthorized discounts on the same item in the same transaction. For example, the consumer 106 is prevented from applying the same 10% discount card 104 multiple times to the same items in a transaction. In some implementations, the same type of transaction rejection occurs when a consumer 106 attempts to use two different discount cards 104, each card issued for the same discount event (e.g., having the same discount event number) and offering discounts to the same products, but each discount card issued to different people.

However, in some implementations, the POS system 108 permits multiple discounts in the same transaction when unique discount events associated with the discount cards are identified. For example, if a consumer 106 holds two different discount cards 104, each card associated with a different promotion or discount event and each card still within its effective period, the POS system 108 honors and processes both discount cards 104, provided all other conditions are met.

If the discount card and account are valid at step 310, an authorization system performs the step of determining 314 if a zero balance is associated with the card. For example, if the discount card 104 has a non-zero balance, the POS system 108, in communication with the authorization system 112, performs the step of allowing 316 the transaction to proceed. However, in implementations of the system 100 in which, for example, a stored value card system is modified to process discount cards, the authorization system 112 performs the step of determining 318 if the card being used in the transaction is a discount card (e.g., the discount card 104).

If the determination at step 318 is that the card being used in the transaction is not a discount card, an authorization system performs the step of generating 320 a default error code. In some implementations, such as when a stored value card having a low or zero balance is used in the transaction, the default error code is a transaction-terminating error code. As a result, in some implementations, the cashier operating the POS terminal 109 sees a message, for instance, indicating “Card has insufficient funds.”

An authorization system performs the step of generating 322 an alternative error code. In implementations of the system 100 in which a stored value card system is modified to handle discount cards (e.g., discount card 104), the authorization system 112 automatically generates the alternative error code. This occurs, for instance, instead of generating the default error code, which would otherwise lead to rejecting the transaction involving the discount card 104 having a zero balance.

A point of sale system performs the step of receiving 324 the alternative error code and approves the transaction. For example, if the POS system 108 receives an alternative error code corresponding to an acceptable zero balance on the discount card 104, the alternative error code is such that the transaction is still approved by the POS system 108.

A point of sale system performs the step of completing 326 the transaction and makes no attempt to debit the balance of the discount card. For example, in the example configuration of FIG. 1, the POS system 108 completes the transaction involving the discount card 104 being tendered by the consumer 106 for the current transaction. In the current example, the cashier continues to interact with the POS terminal 109, such as applying any payment the consumer 106 tenders to pay for the products or services included in the transaction. In some implementations of transactions involving discount cards, the POS system 108 makes no attempt to debit the account, as would otherwise typically be the case for a stored value card.

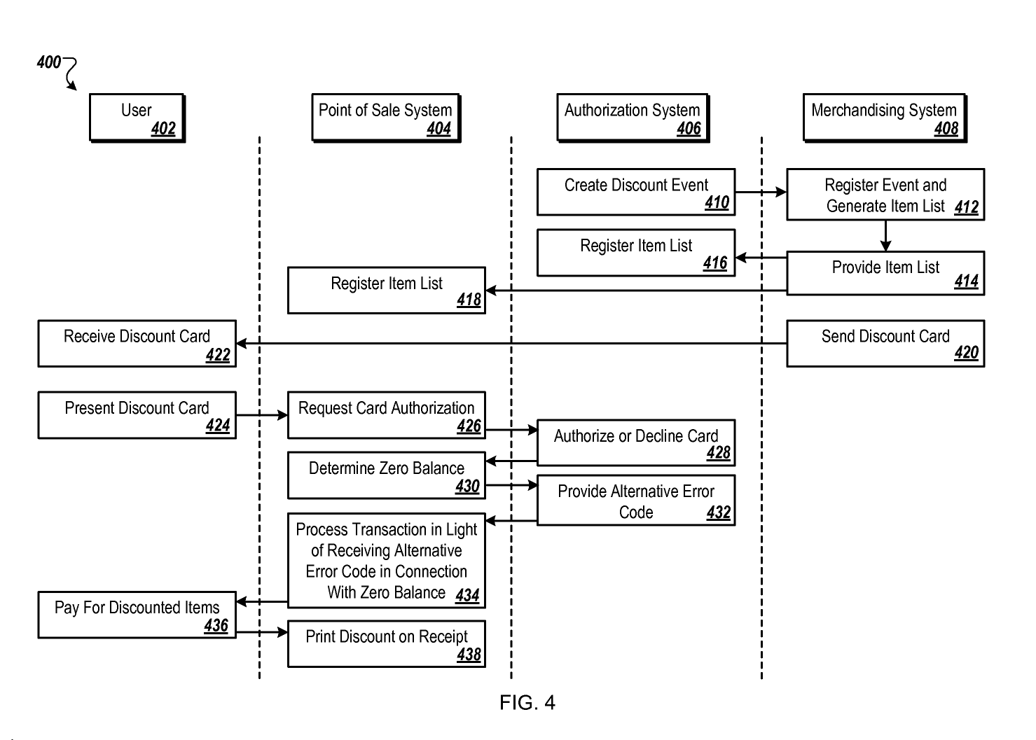

FIG. 4 is a swim lane diagram that illustrates an example process 400 for handling discount cards within a stored value card system. In some embodiments, the process 400 is used for handling discount cards 104, for example, within the system 100 described with respect to FIG. 1. In the example process 400 illustrated in FIG. 4, process steps provide interactions among a user 402, a POS system 404, an authorization system 406, and a merchandising system 408. In some embodiments, the components 402-408 of the process 400 are communicatively coupled using a network (e.g., combinations of the Internet, LANs, WANs, etc.). In the configuration of the example process 400, communication also occurs through interaction among individual people, such as conversational interaction between the user 402 (e.g., a cardholder, or the user 102) and a cashier operating one of the POS terminals included in the POS system 404 (e.g., a POS terminal 109 within the POS system 108).

The user 402 is a person, such as a consumer, who is issued a discount card and who, as the cardholder, ultimately uses the discount card to receive discounts on pre-determined items. In some embodiments, the discounts are percentage discounts, such as a 10% discount off any one or more of a group of items within the category of a branded label. The discounts in other embodiments are absolute discounts, such as five dollars off a particular product-service combination (e.g., oil change) or service (e.g., hair cut). In the example configuration of the system 100, for example, the consumer 106 receives the discount card 104, issued by the merchandising system 110 (e.g., a large discount store).

The point of sale system 404 includes a collection of several POS terminals located in stores where products and services are purchased, such as discount stores, department stores, hardware stores, grocery stores, health facilities, automobile mechanics, haircut shops, and so on. In some embodiments, the point of sale system 404 is the POS system 108 described with respect to FIG. 1.

The authorization system 406 includes a software application that authorizes or rejects the use of a discount card. In some embodiments, the authorization system 406 is the transaction system itself, or is a bank or other financial institution.

The merchandising system 408 includes a software application that controls the items included in discount events and provides discount cards to users. In some embodiments, the merchandising system 408 is a product marketing system or an inventory and pricing system.

The authorization system 406 creates 410 a discount event. In some embodiments, discount events are created by the authorization system 112. The discount event that is created includes, for example, the name of the event (e.g., “2009 Holiday Appreciation”), the intended consumers or other individuals eligible for the event, the event's effective period (e.g., dates and times that the event starts and ends), event parameters (e.g., planned discounts, such as 10%), and the general type of event (e.g., customer/employee appreciation and discount).

The merchandising system 408 registers 412 the discount event and generates a list of items that are discountable under the event. In some implementations, the event is registered by the merchandising system 110, which also generates a list of discountable items related to the event. Generating the list of items, for example, is based on pre-determined lists of items for similar events, including branded items, seasonal items, items having excess inventory, or items nearing the end of their expected shelf life.

The merchandising system 408 provides 414 a list of discount items to the authorization system 406. In some embodiments, the merchandising system 110 maintains lists of items that apply for discount events that are created. For example, referring to the example mailer 200 described with respect to FIG. 2, the list of discountable items include, in some embodiments, all items encompassed by a particular brand or private label.

The authorization system 406 locally registers 416 the list of discount items. For example, the list of items is stored on the POS system 108, effectively caching the list without having to re-access the list from the merchandising system for every transaction that occurs on the POS system 108. In some implementations, the list of items is stored on the authorization system 112, which uses the list to enforce limits or other rules imposed on the general consumer 106, such as allowing only one discount per day per discount card 104, regardless of the various POS terminals that the consumer 106 visits.

The point of sale system 404 locally registers 418 the list of discount items. For example, the POS system 108 stores the list of discount items so that the list need not be retrieved from the authentication system 112 for each transaction.

The merchandising system 408 sends 420 a discount card to the user 402. In the current example, the merchandising system 408 sends a discount card to each person identified by the merchandising system 408 as being eligible for the discount. For example, in some embodiments, the discount cards are sent to all employees of a company who are eligible to receive a 10% discount on specific items purchased in the company's stores.

The user 402 receives 422 the discount card. In some embodiments, receipt of the discount card occurs via regular mail. When received in the regular mail, in some embodiments the discount card resembles the mailer 200 described with respect to FIG. 2, where the mailer includes logos or other brand identifications for which the discounts apply. Other embodiments allow the discount card to be received via email, such as a printable offer or coupon that includes a scan bar that is readable by scanners at POS terminals. In some implementations, the authorization system 406 assigns a unique account/sequence number to each discount card. In certain of these implementations, the authorization system 406 associates users with specific account or sequence numbers. In other implementations, the authorization system 406 uses the same account number for a group of discount cards. In such implementations the discount cards are generic in the sense they are not user specific.

The user 402 presents 424 the discount card. As an example, the consumer 106, now a cardholder, presents the discount card 104 to a cashier or other store worker during a transaction at a POS terminal 109. In some embodiments, the POS terminal 109 is one of several POS terminals 109 at the same store, connected to the POS system 108 by a network, such as a LAN. In some implementations, the consumer waits to use the discount card until after its effective period begins. The effective period of a discount event, in some embodiments, is printed on the mailer 200 that arrives with the discount card 202, or printed directly on the discount card 202.

The point of sale system 404 requests 426 card authorization. In some embodiments, the request is made automatically by the POS system 108 when the cashier who operates the POS terminal 109 scans the discount card 104. In some embodiments, the cashier reads the account number or other identifying information on the discount card 104, which allows the POS system 108 to associate discounts to particular items in the customer's purchase in the current transaction. In the example configuration illustrated in FIG. 1, the authorization request is made to the authorization system 112.

The authorization system 406 authorizes or declines 428 the discount card. In some embodiments, authorization or rejection occurs in the authorization system 112 which either approves or rejects the transaction based on transaction and discount card 104 information received from the POS system 108.

The point of sale system 404 determines 430 that the discount card has a zero balance. In some embodiments, the determination is made in the POS system 108, as shown in the example configuration of FIG. 4. In other embodiments, the authorization system 112 makes the determination, such as during the process of approving or declining the discount card 104. Determining that the discount card 104 has a zero balance, in some embodiments, is made by an existing stored value card system for any type of transaction card, including debit cards, stored value cards and discount cards. For example, the zero-balance determination is made by some implementations of stored value card systems that have been modified to process discount cards.

The authorization system 406 provides 432 an alternative error code. In some embodiments, upon the determination by the authorization system 112 that the transaction card with a zero balance is a discount card 104, the authorization system 112 provides an alternative error code in place of the default error code otherwise used for zero-balance transaction cards. In typical stored value card systems, for example, default error codes are generated for stored value cards having a zero balance. By contrast, the system 100 is a conventional stored value card system modified to use alternative error codes, thus allowing the completion of transactions using discount cards 104 having zero balances.

The point of sale system 404 processes 434 the transaction as the result of receiving the alternative error code. For example, the transaction is processed by the POS system 108, having received the alternative error code from the authorization system 112. In some embodiments, the foregoing actions associated with processing the discount card 104 (and letting the transaction pass through) is transparent to the cashier operating the POS terminal 109. In some embodiments, the message displayed on the POS terminal 109, granting approval of the zero-balance discount card is the same, for example, as the message displayed for the approval of a stored value card with a non-zero balance (e.g., “Transaction Approved”).

The user 402 pays 436 for the discounted items. In the example configuration of FIG. 1, for instance, the user tenders payment to the cashier operating the POS terminal 109. In some examples, the discounted items are part of a larger purchase made by the consumer 106, including items discounted using one or more discount cards 104 and items for which no discounts apply.

The point of sale system 404 optionally prints 438 the discount on the receipt. In some embodiments, the receipt printed by the POS terminal 109 includes a short (e.g., one-line) entry describing the discount, such as a combination of the discount percentage, the discount amount, and the name of the discount event (e.g., “Holiday Appreciation Card”). The printed receipt also optionally includes, in some embodiments, an itemized summary of discounts taken.

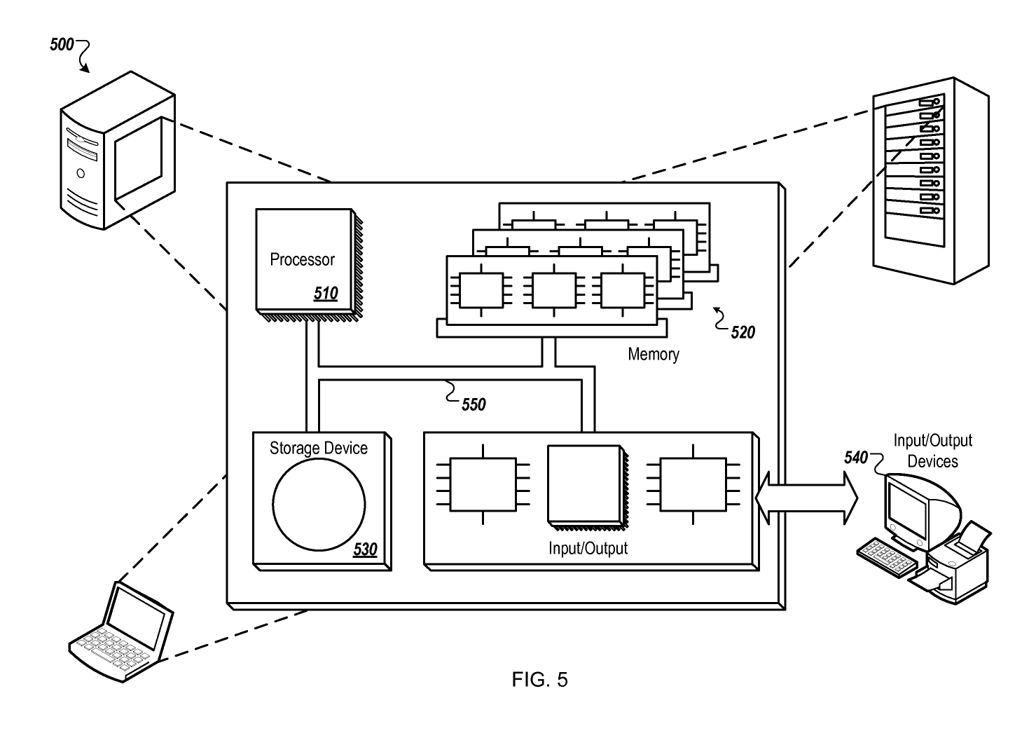

FIG. 5 is a block diagram of a computing system 500 optionally used in connection with computer-implemented methods described in this document. The system 500 is optionally used for the operations described in association with any of the computer-implemented methods described previously, according to some implementations. The system 500 includes a processor 510, a memory 520, a storage device 530, and an input/output device 540. Each of the components 510, 520, 530, and 540 are interconnected using a system bus 550. The processor 510 is capable of processing instructions for execution within the system 500. In some implementations, the processor 510 is a single-threaded processor. In other implementations, the processor 510 is a multi-threaded processor. The processor 510 is capable of processing instructions stored in the memory 520 or on the storage device 530 to display graphical information for a user interface on the input/output device 540.

The memory 520 stores information within the system 500. In some implementations, the memory 520 is a computer-readable medium. In other implementations, the memory 520 is a volatile memory unit. In other implementations, the memory 520 is a non-volatile memory unit.

The storage device 530 is capable of providing mass storage for the system 500. In some implementations, the storage device 530 is a computer-readable medium. In various different embodiments, the storage device 530 is optionally a floppy disk device, a hard disk device, an optical disk device, or a tape device.

The input/output device 540 provides input/output operations for the system 500. In some implementations, the input/output device 540 includes a keyboard and/or pointing device. In other implementations, the input/output device 540 includes a display unit for displaying graphical user interfaces.

In some examples, the features described are implemented in digital electronic circuitry, or in computer hardware, firmware, software, or in combinations of them. The apparatus is optionally implemented in a computer program product tangibly embodied in an information carrier, e.g., in a machine-readable storage device or in a propagated signal, for execution by a programmable processor; and method steps are performed by a programmable processor executing a program of instructions to perform functions of the described embodiments by operating on input data and generating output. The described features are optionally implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that are optionally used, directly or indirectly, in a computer to perform a certain activity or bring about a certain result. A computer program is optionally written in any form of programming language, including compiled or interpreted languages, and it is deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory are optionally supplemented by, or incorporated in, ASICs (application-specific integrated circuits).

To provide for interaction with a user, the features in some instances are implemented on a computer having a display device such as a CRT (cathode ray tube) or LCD (liquid crystal display) monitor for displaying information to the user and a keyboard and a pointing device such as a mouse or a trackball by which the user provides input to the computer.

The features are optionally implemented in a computer system that includes a back-end component, such as a data server, or that includes a middleware component, such as an application server or an Internet server, or that includes a front-end component, such as a client computer having a graphical user interface or an Internet browser, or any combination of them. The components of the system are connected by any form or medium of digital data communication such as a communication network. Examples of communication networks include, e.g., a LAN, a WAN, and the computers and networks forming the Internet.

The computer system optionally includes clients and servers. A client and server are generally remote from each other and typically interact through a network, such as the described one. The relationship of client and server arises by virtue of computer programs running on the respective computers and having a client-server relationship to each other.

A number of embodiments have been described. Nevertheless, it will be understood that various modifications are optionally made without departing from the spirit and scope of this disclosure. Accordingly, other embodiments are within the scope of the following claims.

What is claimed is:

1. A stored value card system for tracking and processing discount cards, the system comprising:
a point of sale system, including at least a portion of a software application, operable to process transactions using transaction cards including credit cards, stored value cards and discount cards, wherein the discount cards provide one or more discounts applicable to the purchase of one or more items; and
an authorization system, including at least a portion of a software application, operable to provide transaction card information to the point of sale system, the information being used to track transaction card balances, approve transactions, and generate error codes associated with the transaction cards, wherein the authorization system is further operable to:
i) generate a first error code that comprises a default error code for a condition that exists for certain transactions, wherein the default error code normally causes the transaction to be rejected, and
ii) determine when one of the discount cards is being used for transactions and to generate for certain of such transactions a second error code that comprises an alternative error code, wherein the alternative error code is generated when a discount card having a zero balance is used in a transaction;
wherein the point of sale system is further operable to determine whether discount cards used for transactions have a zero balance, to receive from the authorization system for such transactions the second error code, to process such transactions as null value transactions, and to approve and complete such transactions.

2. The system of claim 1 further comprising:
a merchandising system including at least a portion of a software application, wherein the merchandising system is operable to receive, from the authorization system, notification of a discount event;
wherein the merchandising system provides, to the point of sale system and the authorization system, a list of discountable items that correspond to the discount event; and
wherein the authorization system issues one or more discount cards to users for use at the point of sale system, the discount cards providing discounts on the one or more discountable items during the discount event.

3. The system of claim 2, wherein authorization of a transaction includes determination of whether the discount event is still active and whether items included in the transaction are associated with the discount event.

4. The system of claim 2, wherein the point of sale system permits multiple discounts on the same item in the same transaction only for certain discount events.

5. The system of claim 1, wherein the first error code is not transmitted to the point of sale system in connection with transactions for which the second error code is generated.

6. The system of claim 1, wherein the discount cards are printed discount cards identifying discounts available for specific items purchased while using the printed discount cards, wherein the printed discount cards include logos or brand identifications for items or product lines for which discounts are allowed when using the printed discount cards, wherein the printed discount cards are delivered to the user with information describing the discounts.

7. The system of claim 1, wherein one or more user interfaces associated with the point of sale system includes modified or additional displays, prompts or notifications associated with the processing of discount cards.

8. A method for tracking and processing discount cards, the method comprising:
processing, in a point of sale system, transactions using transaction cards including credit cards, stored value cards and discount cards, wherein certain of said transaction cards serve as both stored value and discount cards;
receiving, from a transaction system, a first notification for transactions involving transaction cards used to receive discounts on inventory items during a sales promotion, the first notification causing certain transactions to be rejected;
receiving, from the transaction system, a second notification in place of the first notification, the second notification indicating that a transaction card that serves as both a stored value card and a discount card and has a zero balance is being used in connection with a transaction;
rejecting, at the point of sale system, transactions when the first notification is received; and
approving, at the point of sale system, transactions when the second notification is received in place of a first error code.

9. The method of claim 8 further comprising:
receiving, in the transaction system, notification of the sales promotion, the notification received from an inventory and pricing system;
providing, to the point of sale system and the transaction system, a list of discountable inventory items that correspond to the sales promotion, the list being provided by the inventory and pricing system; and
issuing one or more discount cards to users for use at the point of sale system, the discount cards providing discounts on the one or more discountable inventory items during the duration of the sales promotion.

10. The method of claim 9, further comprising:
determining, in the transaction system, whether the sales promotion associated with a transaction using a discount card is still in effect and whether inventory items included in the transaction are associated with the sales promotion;
approving, in the transaction system, transactions for inventory items included in the sales promotion that are still in effect; and
rejecting, in the transaction system, discounts for inventory items not included in the sales promotion or for discounts associated with the sales promotion if the sales promotion is no longer in effect.

11. The method of claim 9, further comprising preventing, at the point of sale system, multiple discounts on certain inventory items in the same transaction.

12. The method of claim 8, wherein the discount cards are printed discount cards that include logos or brand identifications for inventory items or product lines for which discounts are allowed and wherein the printed discount cards are delivered to the user with information describing the discounts.

13. The method of claim 8, wherein one or more user interfaces associated with the point of sale system includes modified or additional displays, prompts or notifications associated with processing discount cards.

14. A physical computer-readable medium, embodied in a device, on which medium is encoded program code configured for execution by a processor to perform a method for tracking and processing discount cards, the method comprising:
processing, in a point of sale system, transactions using transaction cards including credit cards, stored value cards and discount cards, wherein the stored value cards also serve as transaction cards;
receiving, from a transaction system, a first error code that serves as a default error code for a condition that is raised for transactions involving transaction cards used to receive discounts on inventory items during a reward campaign, the default error code causing the affected transactions to be rejected;
receiving, from the transaction system when the transaction system is further operable to determine when a discount card is being used, a second error code that serves as an alternative error code in place of the default error code for the discount card, the alternative error code being generated when a discount card having a zero balance is used in a transaction; and
approving the transaction in the point of sale system, based on receiving, from the transaction system, the second error code.

15. The computer-readable medium of claim 14 wherein the method further comprises:
receiving notification of a reward campaign, the notification received from a product marketing system;
providing, to the point of sale system and a financial institution, a list of discountable products and services that correspond to the reward campaign, the list provided by the product marketing system; and
issuing one or more discount cards to users for use at the point of sale system, the discount cards providing for the users to receive discounts on the one or more discountable products and services during the reward campaign.

16. The computer-readable medium of claim 15, wherein the method further comprises:
determining whether the reward campaign associated with a transaction using the discount card is still in effect and whether products and services included in the transaction are associated with the reward campaign;
approving transactions for products and services included in the reward campaign that are still in effect;
rejecting transactions for products and services not included in the reward campaign or for discounts associated with the reward campaign if the reward campaign is no longer in effect; and
deactivating discount cards for reward campaigns that are no longer in effect.

17. The computer-readable medium of claim 15, wherein the method further comprises preventing, in the point of sale system, multiple discounts on the same product or service in the same transaction.

18. The computer-readable medium of claim 14, wherein the discount cards are printed discount cards identifying discounts available for specific products or services purchased while using the printed discount cards, wherein the printed discount cards include logos or brand identifications for products or services for which discounts are allowed when using the printed discount cards, wherein the printed discount cards are delivered to the user with information describing the discounts.

19. The computer-readable medium of claim 14, wherein one or more user interfaces associated with the point of sale system includes modified or additional displays, prompts or notifications associated with processing of discount cards.

20. The computer-readable medium of claim 14, wherein the first error code is not transmitted to the point of sale system if the second error code is transmitted to the point of sale system in connection with a given transaction.
